(19) United States
(12) Patent Application Publication
(10) Pub. No.: US 2019/0109882 A1
(43) Pub. Date: Apr. 11, 2019

(54) System and Method for Assembling and Playing a Composite Audiovisual Program Using Single-Action Content Selection Gestures and Content Stream Generation

(71) Applicant: Unroll, Inc., West Hollywood, CA (US)

(72) Inventors: Matt Thompson, West Hollywood, CA (US); Ian Ulery, Los Angeles, CA (US)

(21) Appl. No.: 16/153,568

(22) Filed: Oct. 5, 2018

Related U.S. Application Data
(63) Continuation of application No. 15/227,817, filed on Aug. 3, 2016, now abandoned.
(60) Provisional application No. 62/200,515, filed on Aug. 3, 2015.

(51) Int. Cl. H04L 29/06; G06F 16/438; H04L 29/08; G06F 16/783

(52) U.S. Cl. CPC H04L 65/60; G06F 16/4387; G06F 16/783; H04L 65/4069; H04L 67/02

(57) ABSTRACT

A system and method for providing a composite audiovisual program for rendering by a video player. The method includes receiving a request for available program segments and sending information relating to the available program segments. Selection information corresponding to selected ones of the available program segments that have been selected for inclusion in a play queue is also received. Available program segments may be selected in response to a single gesture provided through a user interface of an application program including the video player. The method further includes receiving requests for a sequence of segment files identified by variant playlist information associated with the selected ones of the available program segments. The sequence of segment files may be provided by a media repository such that the sequence of segment files are rendered by the video player without buffering between the selected ones of the available program segments.

### CROSS-REFERENCE TO RELATED APPLICATIONS

The present application is a continuation of U.S. patent application Ser. No. 15/227,817, entitled SYSTEM AND METHOD FOR ASSEMBLING AND PLAYING A COMPOSITE AUDIOVISUAL PROGRAM USING SINGLE-ACTION CONTENT SELECTION GESTURES AND CONTENT STREAM GENERATION, filed on Aug. 3, 2016, which claims the benefit of priority under 35 U.S.C. § 119(e) of U.S. Provisional Application Ser. No. 60/220,0515, entitled SYSTEM FOR ASSEMBLING AND PLAYING A COMPOSITE AUDIOVISUAL PROGRAM USING A PLAY QUEUE, filed Aug. 3, 2015, the content of each of which is hereby incorporated by reference herein in its entirety for all purposes.

### FIELD

The disclosure relates to the transmission of data relating to digital content, such as digitized audiovisual program content. More specifically, the disclosure relates to techniques for streaming media or for otherwise providing digitized media for playback.

### BACKGROUND

Streaming media services are an increasingly popular way to consume audiovisual content. Typically, the audiovisual content is stored on a server and received by a client device. The content may be rendered by an application on the client device while it is being provided by the server.

Streaming media service providers generally endeavor to provide viewers with a seamless and intuitive user experience. However, it is often cumbersome for a user to select multiple items of content to be viewed in single viewing session.

Moreover, technical challenges exist in enabling content from multiple audiovisual programs to be played in series without visible buffering.

### SUMMARY

In one aspect, the disclosure relates to a system and method for enabling a composite audiovisual program comprised of multiple program segments to be viewed without visible buffering. In one embodiment the program segments comprising the composite audiovisual program may be changed even after playback of the pre-assembled audiovisual program has begun. Program segments may be added to a play queue with single-action content selection gestures, thereby obviating the need to define or develop playlists or the like.

In one embodiment the system and method described herein combine a play queue (e.g., representing a user's composite audiovisual program), single-action content selection gestures, and a content stream generation component. This combination allows dynamic, multi-segment video programs to be viewed with looped or unlooped playback and without buffering between segments.

In a particular aspect the disclosure pertains to a method for providing a composite audiovisual program for rendering by a video player. The method includes receiving a request for available program segments and sending information relating to the available program segments. The method further includes receiving selection information corresponding to selected ones of the available program segments that have been selected for inclusion in a play queue. Requests for a sequence of segment files identified by variant playlist information associated with the selected ones of the available program segments are also received. In one implementation the variant playlist information is generated based at least in part upon resolutions of the selected ones of the available program segments. The method further includes sending, in response to the requests, the sequence of segment files from a media repository wherein the sequence of segment files is rendered by the video player without buffering between the selected ones of the available program segments.

The disclosure is also directed to an alternate method for assembling and rendering a composite audiovisual program. The method includes sending a request for available program segments and receiving information relating to the available program segments. The method further includes receiving, through a user interface of an application program including a video player, selections of ones of the available program segments for inclusion in a play queue. Variant playlist information may be generated by identifying at least one sequence of segment files associated with the selected ones of the available program segments. In one implementation the variant playlist information is generated based at least in part upon resolutions of the selected ones of the available program segments. The method further includes sending a request for the at least one sequence of segment files and retrieving the at least one sequence of segment files from a media repository. The at least one sequence of segment files are then rendered without buffering between the selected ones of the available program segments.

In a further aspect, the disclosure relates to another method for providing a composite audiovisual program for rendering by a video player. The method includes receiving a request for available program segments and sending information relating to the available program segments. The method further includes receiving selection information corresponding to selected ones of the available program segments that have been selected for inclusion in a play queue. Each of the selected ones of the available program segments may be selected for inclusion in the play queue in response to a single gesture provided through a user interface of an application program including the video player. The method further includes receiving requests for a sequence of segment files identified by variant playlist information associated with the selected ones of the available program segments. The sequence of segment files are then provided by a media repository such that the sequence of segment files may be rendered by the video player without buffering between the selected ones of the available program segments.

The disclosure describes yet a further method for assembling and rendering a composite audiovisual program. The method includes sending a request for available program segments and receiving information relating to the available program segments. The method further includes receiving, through a user interface of an application program including a video player, selections of ones of the available program segments for inclusion in a play queue wherein each of the selections are made using a single gesture. Variant playlist information is then generated by identifying at least one sequence of segment files associated with the selected ones of the available program segments. The method further includes sending a request for the at least one sequence of segment files and retrieving the sequence of segment files from a media repository. The sequence of segment files are then rendered without buffering between the selected ones of the available program segments.

### BRIEF DESCRIPTION OF THE DRAWINGS

FIG. 1 is a diagram showing interaction of components as a user creates and plays a composite video program, according to an embodiment.

FIG. 2 is a web service response, according to an embodiment.

FIG. 3 is a client application user interface wireframe, according to an embodiment.

FIGS. 4A-4D are a web service database schema, according to an embodiment.

FIG. 5 is a chart showing the process of adding and removing media from a user's composite program, according to an embodiment.

FIG. 6 is a play queue interface wireframe, according to an embodiment.

FIG. 7 is an HLS video on demand variant playlist, according to an embodiment.

FIG. 8 is an HLS master playlist, according to an embodiment.

FIG. 9 is a diagram showing interaction between the play queue, content stream generator, player user interface, and media repository during playback, according to an embodiment.

FIG. 10 is a diagram showing interaction between the client application, player user interface, and web service, according to an embodiment.

FIG. 11 is a diagram showing interaction between the client application, player user interface, and web service, according to an embodiment.

### DETAILED DESCRIPTION

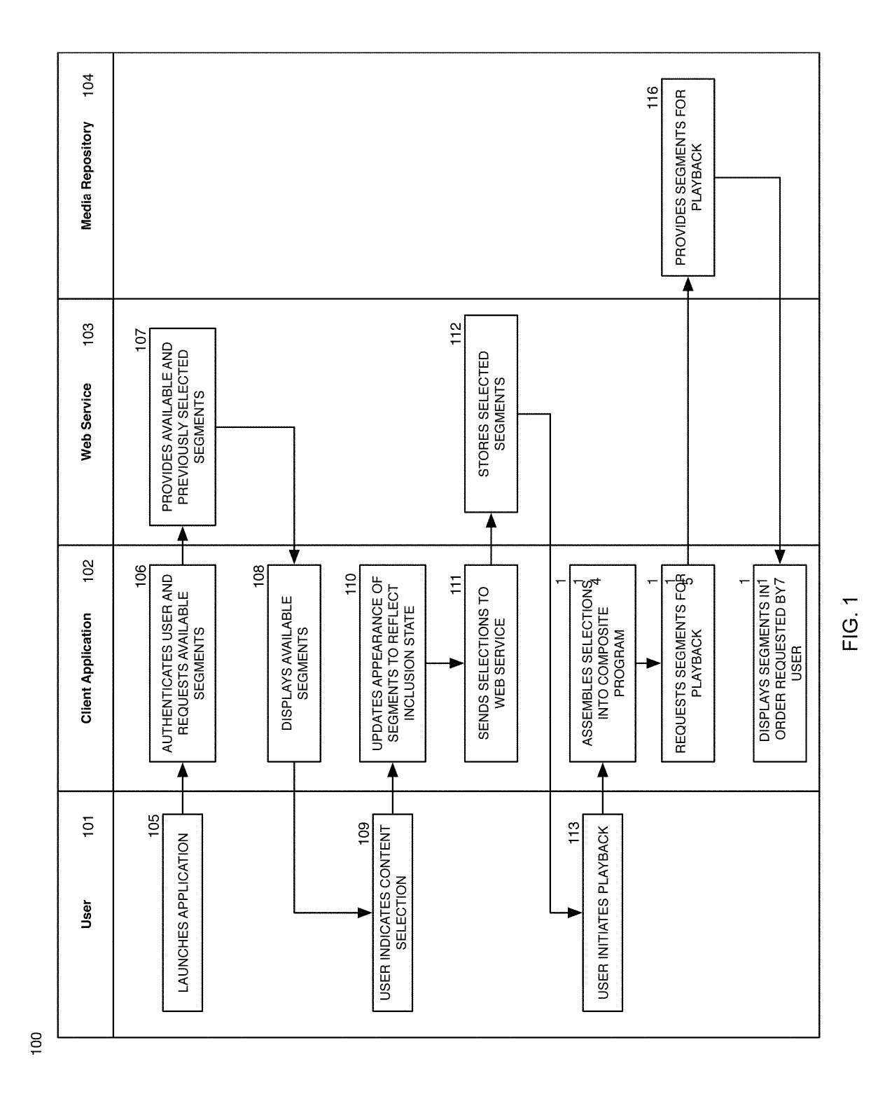

In one embodiment, systems and methods herein can comprise three high-level components: a client application 102, web service 103, and media repository 104. Example implementation details of each component are discussed in the context of assembling and playing a composite audiovisual program, following the diagram in FIG. 1.

Users can interact with the system through a client application. In one embodiment, the client application can be an iPhone and/or similar application (referred to as “the app”). The client application can communicate with a web service over the Internet, such as a Ruby on Rails web application hosted on a Heroku cloud platform with a Postgres database.

To exchange information with the web service, the app can verify the user's identity 106. The user can enter their username and password, which can be sent over the Internet via an SSL encrypted HTTP request to the web service, in accordance with the OAuth 2.0 resource owner password credentials grant flow and/or in accordance with a similar authentication framework. The web service can check a relational database to determine whether the username and password correspond to an existing user account. A Blowfish encryption algorithm (bcrypt), and/or a similar encryption process and/or algorithm, can be applied to the input password, the web service can determine whether the resulting hash exists in a users table. If a matching record is present, the web service can generate an access token (e.g., a 32-bit and/or similar access token) to identify the user. The web service can store the access token in a database to authenticate future requests, and can return the access token to the app. The app can store the access token in memory, and/or using a service for storing access tokens, e.g., Apple's iOS Keychain Service, a similar keychain service, and/or a similar service.

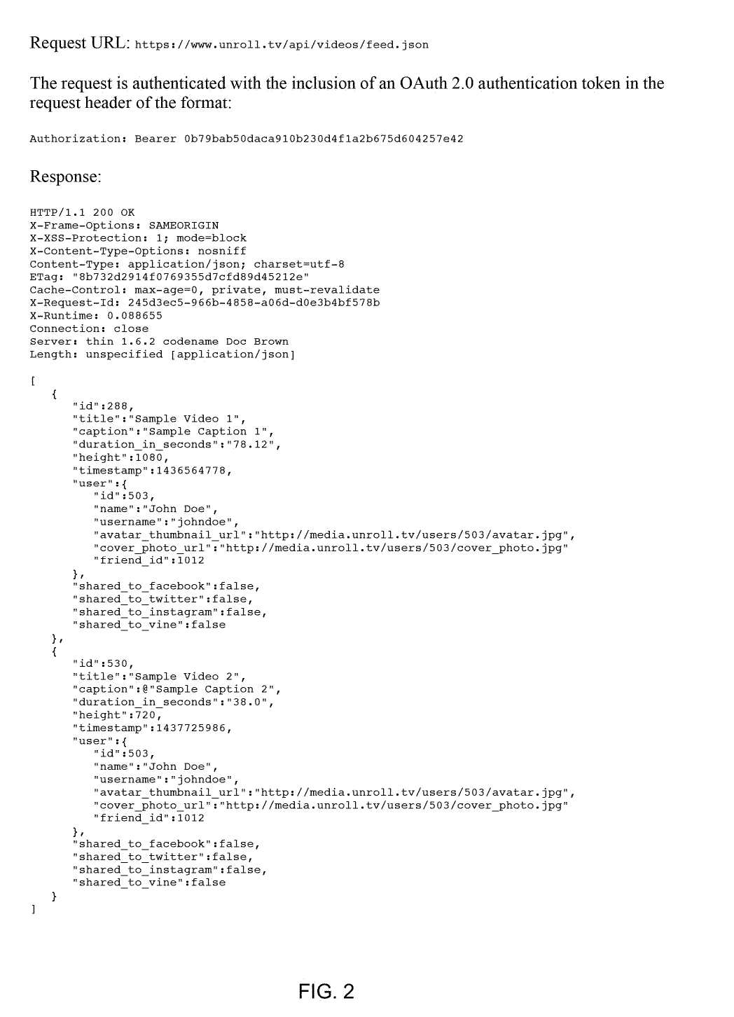

After authenticating, the app allows the user to browse available media. To retrieve information about available media, the app can send SSL encrypted HTTP requests to the web service, providing the user's authentication token and/or other information as a request header. The web service can authenticate the token, and return media segments for the corresponding view, e.g., in a JavaScript Object Notation (JSON) 107 and/or similar format. A sample response from the web service is shown in FIG. 2.

Upon receiving a JSON response from the web service, the app can convert the response into an internal representation. For example, the app can parse the body of the HTTP response (e.g., the body of a JSON response), and can generate an array of dictionary objects based on the contents of the body of the HTTP response. The app can iterate through the array and, for each dictionary object, instantiate a value object in memory on the device (e.g., in a heap data structure stored in the memory of the device). The value object's properties can be set based on the properties of the dictionary object, and a pointer to the instantiated value object can be added to a result array stored in memory. The app can use the result array of object pointers to manage the internal state of the app, and to display output at the app.

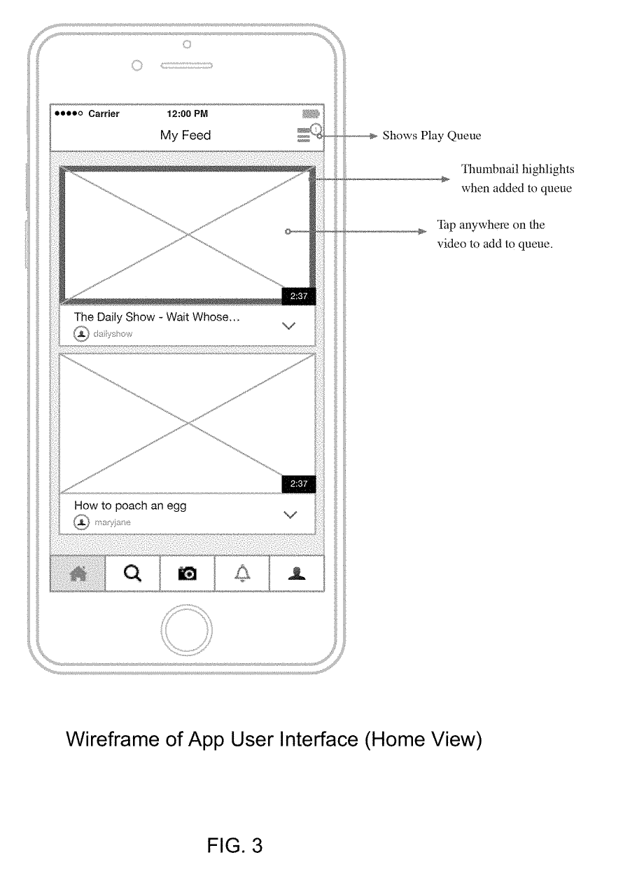

The app can display information about available media segments, e.g., using information from the array of value objects. The app can use, as an example, instances of Apple's UITableView class 108 to display information about media segments. The array of value objects can be used as the data source for a table view. Each cell in the table view can display information associated with each segment in the array. An example wireframe of the app's user interface is shown in FIG. 3.

When a table cell is created for a segment, the cell's appearance can be tinted and/or otherwise augmented and/or modified if a user has selected the segment for inclusion in a composite audiovisual program. The app can determine whether a media segment is included in a playlist by checking a central “play queue” within the app. The app's play queue can represent the composite program assembled by the user. The play queue can be, for example, an object instantiated in memory (e.g., an object instantiated in a heap data structure stored in the device's memory) that contains an array of media segment object pointers, and a dictionary of those same pointers indexed by a segment's unique numeric identifier. When a table view cell is prepared for display, the play queue dictionary can be queried using the media segment's unique numeric identifier as a key. If the dictionary returns a pointer, the cell corresponding to the media segment can be tinted to indicate that it has been added to the user's composite media program. If the dictionary returns a nil reference, the cell can remain un-tinted.

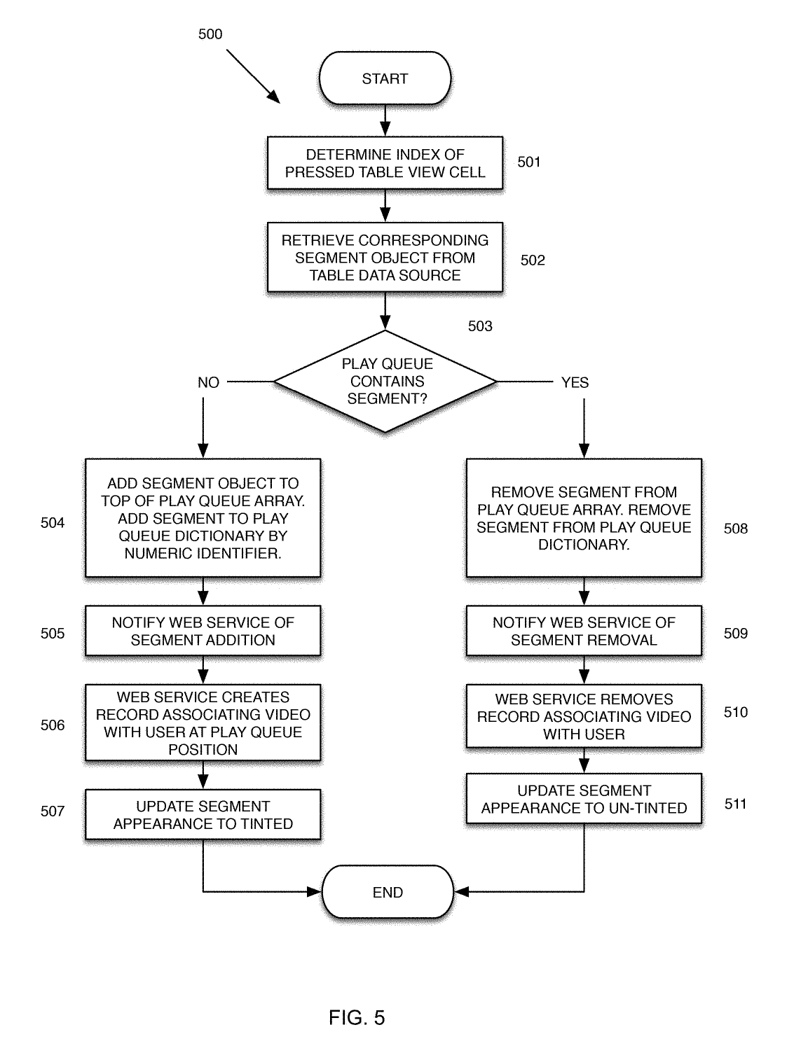

The user can then add and remove segments from their composite audiovisual program, e.g., by pressing on the segment's corresponding table view cell 109. When the user presses on a cell, the table view can determine the index of the cell that was pressed 501, and can use the index of the cell to retrieve a corresponding media segment object from a data source array 502. A play queue's dictionary can be queried with a media segment's unique identifier obtained from the media segment object to determine whether the media segment is included in a play queue. If the segment is not included in the play queue, the segment's pointer can be appended to the beginning of the play queue's segment array, and the pointer can separately be added to the play queue's dictionary, e.g., indexed by the segment's numeric identifier 504. If the segment is included in the play queue, the segment pointer can be removed from both the array and the dictionary. The tint state of the table view cell can then be updated to reflect that it has been removed from the play queue 508. An example process is depicted in FIG. 5.

In alternate embodiments, gestures other than tapping can select media for inclusion in the composite media program. Other gestures can include swiping, panning, pinching, rotating, pressing, pressing and holding, or dragging and dropping. Media selection gestures can also perform actions in addition to adding media to the composite media program. For example, pressing and holding on a media item can add the media item to the composite media program and initiate playback.

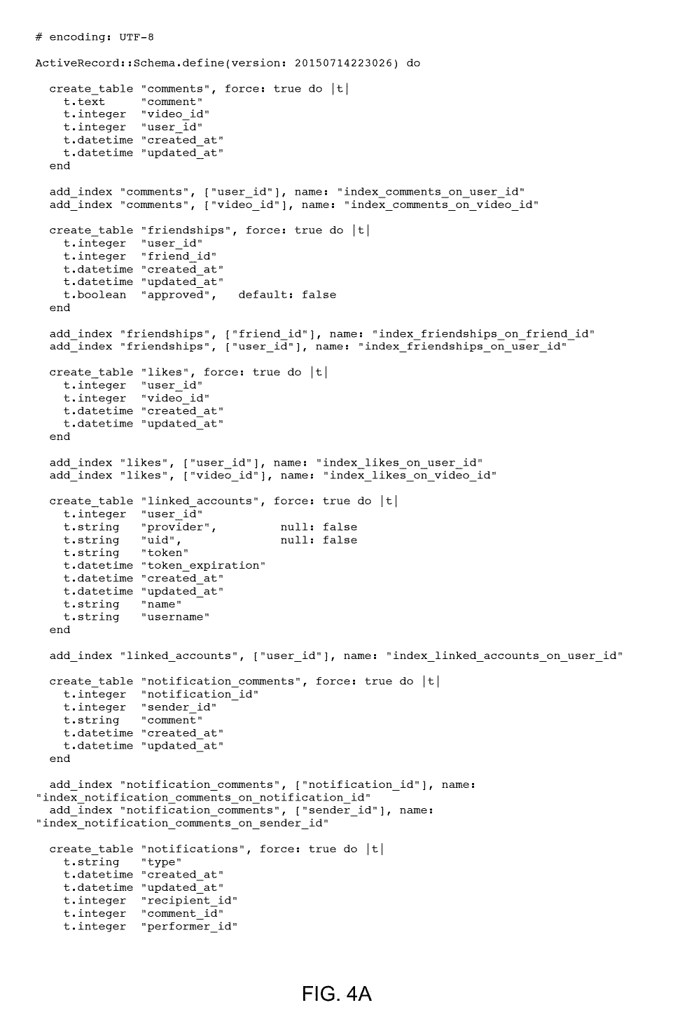

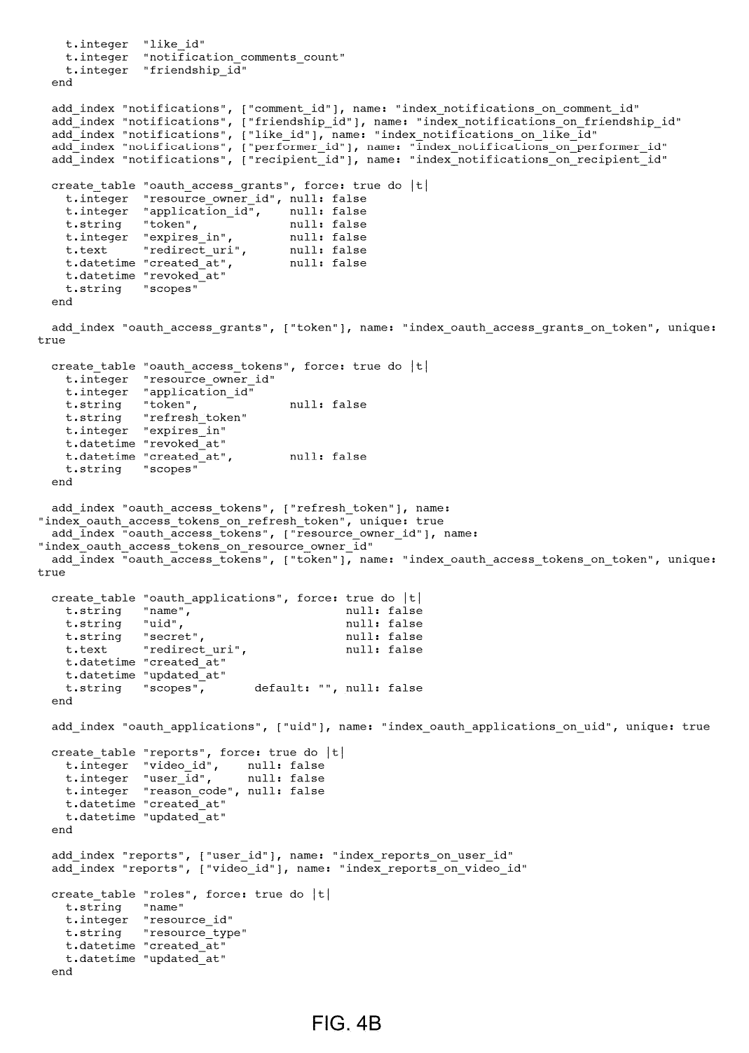

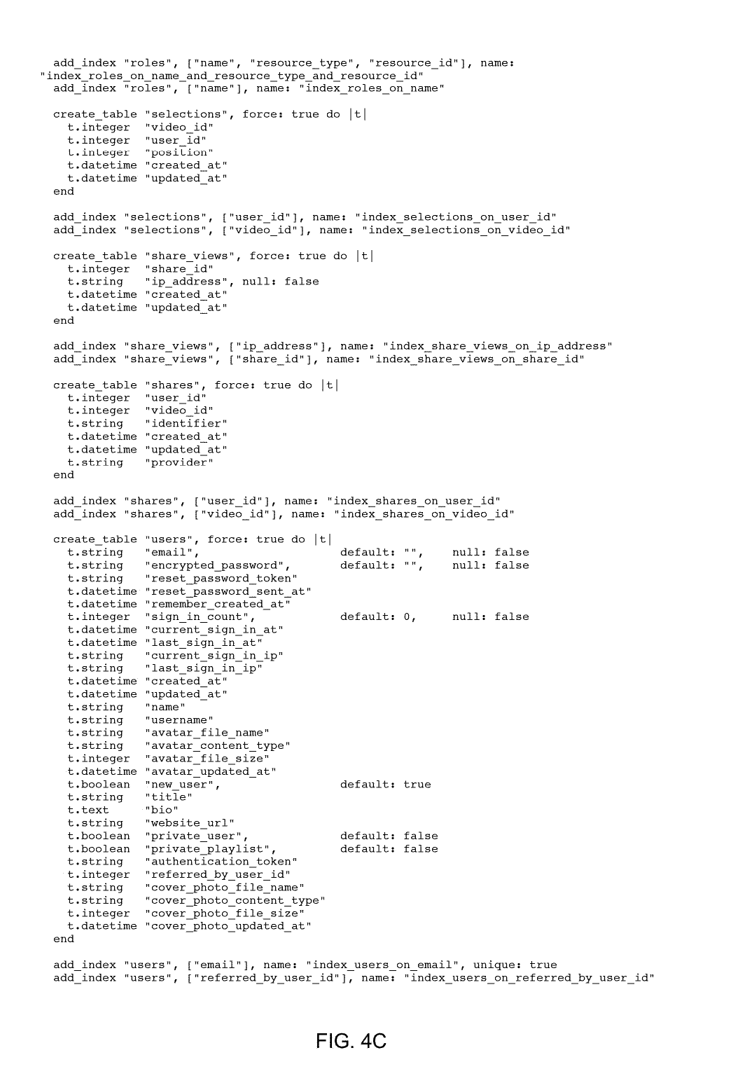

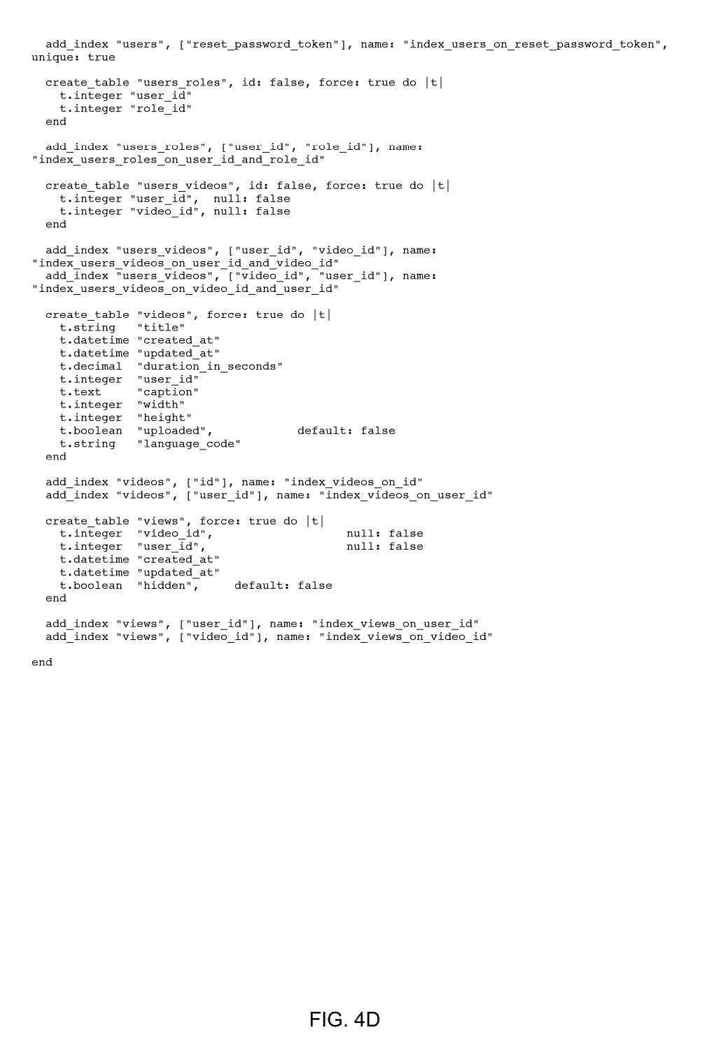

The app can send a request to the web service when the user adds or removes segments from their play queue. For example, when a segment is chosen for inclusion in the play queue, an HTTPS POST request can be sent to the web service, containing a numeric identifier of the chosen segment and the user's authentication credentials (e.g., an OAuth token 505). The web service can resolve the authentication token to a user (e.g., can authenticate the user by determining whether or not the authentication credentials provided to the web service match credentials associated with the user, and/or the like), and can create a database record linking the media segment to the user, e.g., with an integer value representing the segment's position in the user's play queue 506. An example schema for this record is depicted in FIG. 4 (“selections” table). When a segment is removed from the play queue, the app can issue an HTTPS DELETE request to the web service, where the request can include the segment's unique identifier and the user's OAuth token 509. The web service can resolve the OAuth token to the user, and can delete the corresponding database record linking the segment to the user 510.

A single, app-wide play queue, and single-action gestures for adding and removing content can obviate the need to create playlists, or to select playlists to which to add content, each process typically being multi-step processes. Composite program assembly using single-action gestures can create improvements in user experience, e.g., due to the specific combination of a play queue and single-action gestures.

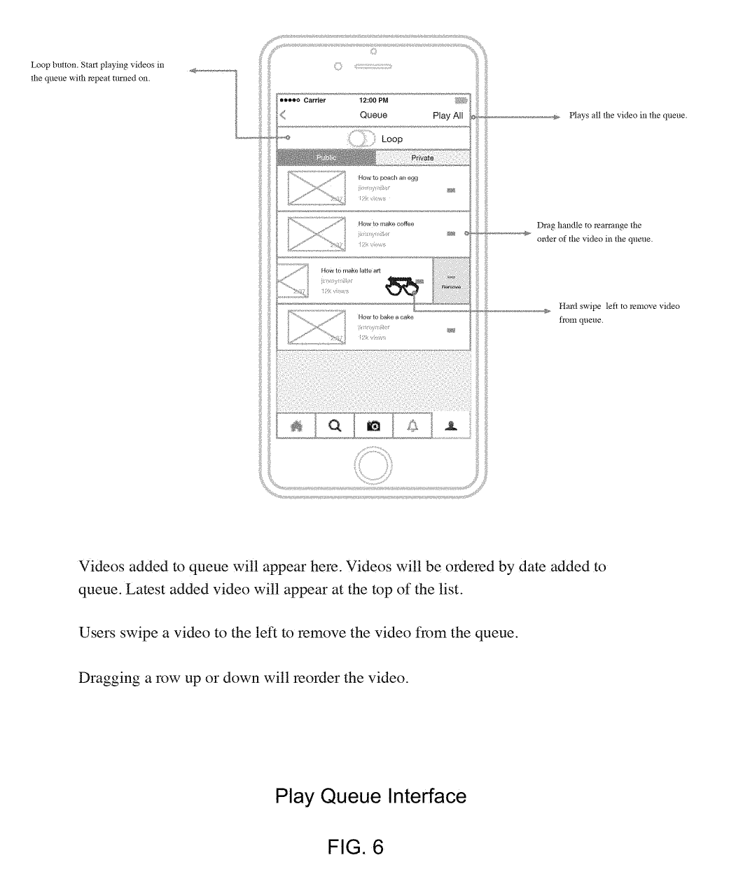

When the user is ready to view their composite program, the user can press a “play queue” button. The app can present the contents of the play queue in a user interface (e.g., a UITableView interface), with each segment represented as a row in the table. The table view can allow the user to press and drag rows to arrange the segments into the desired playback order. When the user releases a dragged row, the order of the play queue's internal array can be updated to reflect the order of the table view cells. An example interface is shown in FIG. 6.

In alternate embodiments, the play queue interface can be combined with the player component. For example, a button can present the player component and begin playback. The play queue view can be a sub-component of the player component. Tapping on a button within the player component can show the play queue view. The play queue player sub-component can have the same interface shown in FIG. 6.

To initiate playback, a user can press a “play” button. The user's play queue array is passed to a component within the app that generates a live content stream (e.g., a player user interface HTTP Live Streaming (HLS) live content stream). The content stream generator can be a class that is binded to a TCP port on the device on which the client application is running, and can allow the device to function as a web server (and/or the client application to function as a virtual web server). The provider of the live content can listen for incoming HTTP requests on the device's internal loopback (127.0.0.1) or external IP address. When an HTTP request is received, the content stream generator can invoke a corresponding subroutine to create a response, e.g., based on the URL of the incoming request. The stream generator can generate a master live content stream playlist file, and live-format stream variant playlist files. The content stream generator can be instantiated at runtime, and can be shared throughout the app using dependency injection.

Known playlists can be immutable once they are created. Further, mobile devices can be configured to prohibit playback of certain types of playlists from local storage. The content stream generator can allow the device play a composite program with seamless transitions between segments, while also allowing the program contents to change during playback, by leveraging adaptive-bitrate playback of multi-segment playlists, and by generating sliding window format playlists, and assembling those playlists in real-time. Using sliding windows with live content playlists can allow the delivered audiovisual program to have both an adaptive bitrate, seamless transitions between videos, and changeable content. Furthermore, the content stream generator can bind to a port on the device running the client application, and can serve playlists via HTTP to circumvent device limitations on playlist playback.

Before responding to requests, the content stream generator can prepare its internal state upon receiving the user's play queue array. When the stream generator is sent a message to update its play queue array with a provided array of segments, the invoked subroutine can enumerate through each segment in the array. For each segment, a number of files (e.g., MPEG-2 Transport Stream (TS) files) can be determined by dividing the total video duration (e.g., by a value equal to the target duration in seconds of each transport stream file). The duration of the last transport stream file can be computed as the remainder of dividing the total segment duration, or can be determined as being the target duration of the transport stream file if the remainder is zero. The subroutine can generate a record marker entry for each transport stream file (e.g., an #EXTINF record marker entry). If the transport stream file is the first for a segment, a tag (such as an #EXT-X-DISCONTINUITY tag) is prepended to the marker. A wrapper object can be instantiated to encapsulate the marker string and duration in seconds of the transport stream file, and the encapsulation object can be appended to an array. This array can be stored by the stream generator, and can be used by internal generator subroutines to create variant playlists.

The client application can display a video playback interface (such as a playback interface incorporating Apple's AVPlayer class). The video playback interface can make an HTTP request for a master playlist to the loopback IP address of the device running the client application, e.g., on port 8080. The player can begin playback when it receives the playlist response from the content stream generator.

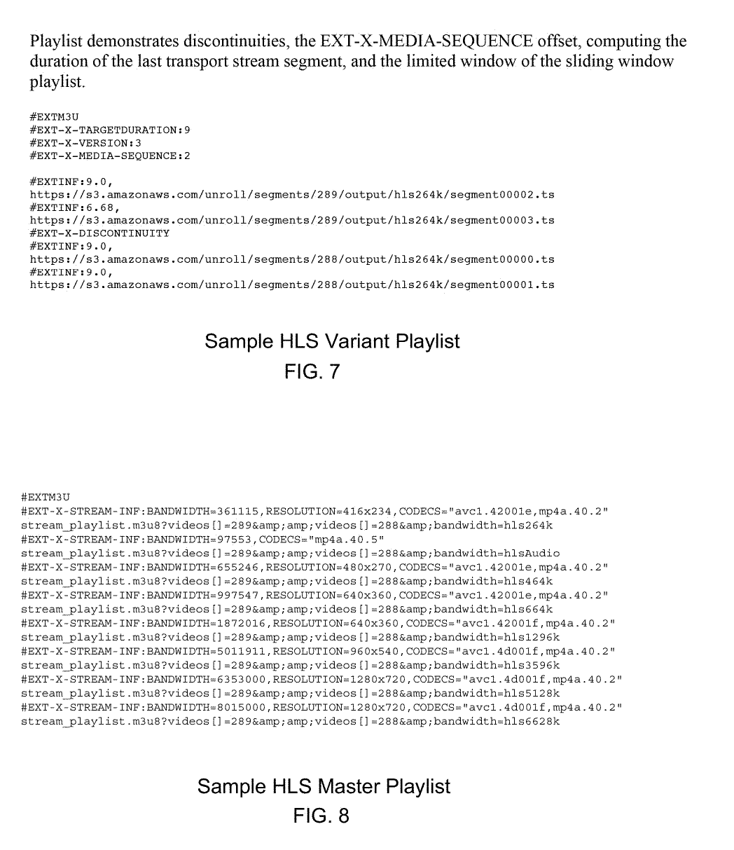

When the stream generation component receives a request from the video playback interface for a master playlist, the stream generation component invokes a subroutine to create the response. The subroutine begins building the response by appending initial headers (e.g., HLS headers) to the output. The stream generation component can then iterate through each segment in the play queue array to identify a video segment with a low resolution, e.g., by comparing a height dimension in pixels of each video segment, to the height dimensions of each other video segment. Variant playlist references can be appended to the master playlist, up to a highest common resolution within the composite program. An audio-only variant can also be included in the master playlist. The stream generator can then return the playlist as a document with “application/x-mpegURL” MIME type. An example HLS playlist is shown in FIG. 7.

Upon receiving the master playlist, the video playback component can load the first variant playlist. The video playback interface can make a determination about the playback device's network connectivity by measuring data transfer speeds between the device and media repository. Based on available bandwidth, the video playback interface can then select an appropriate variant playlist for which uninterrupted playback can be maintained. The video playback interface can make a request for a corresponding variant playlist from the stream generator component by issuing a request to the IP address on which the stream generator component is bound, e.g., the request including a specific URL for the playlist.

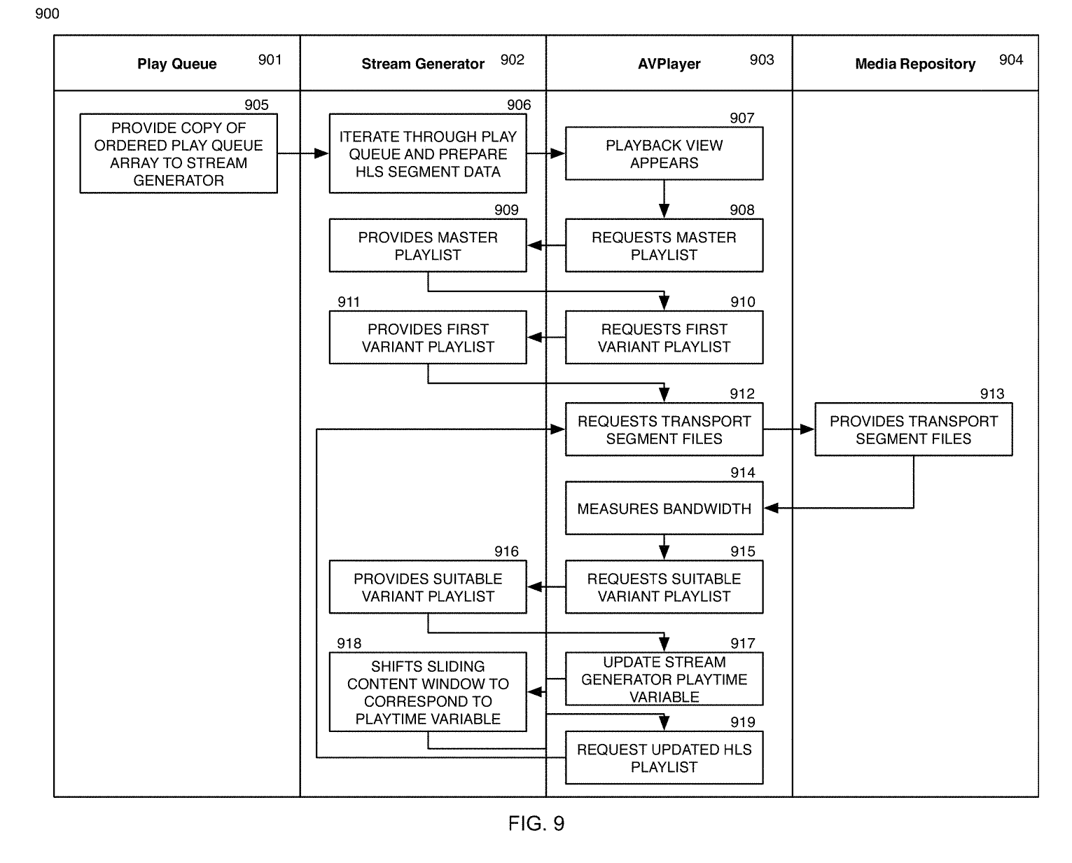

When a request is received for a variant playlist, the stream generator component can execute a subroutine to generate the response. The subroutine can append tags to the beginning of the output identifying the response as a variant playlist with a sliding window. The subroutine can check an variable indicating the playtime of the app's video player. The subroutine can identify which record marker index corresponds to the player's current play time, e.g., by iterating through the array of record marker encapsulation objects created when the play queue was set, until the playtime is greater than or equal to the sum of all previous transport stream file durations. If looping is enabled, a modulo operation can be performed on the index, such that if the end of the playlist is reached, the iterator continues from the beginning of the playlist. The subroutine can append the identified index to the output (e.g., as an #EXT-X-MEDIA-SEQUENCE value). The subroutine can then append the record marker string for the corresponding entry to the response output, as well as the following three record markers. If looping is not enabled, markers can be returned until the end of the array, and when the end of the array is reached, a tag (e.g., an #EXT-X-ENDLIST tag) can be appended to the output. The response is then returned as a document (e.g., a document with a “application/x-mpegURL” MIME type). A sample variant playlist is shown in FIG. 8. An example interaction during playback between the play queue, stream generator, media repository, and the video playback interface is shown in FIG. 9.

The user can also enable and disable looping with a button in the player user interface. When the looping button is enabled, the player user interface can set a looping parameter on the content stream generation component to true. If looping is toggled off, the player user interface can set the looping parameter on the stream generator to false. The player user interface can then be de-allocated and re-instantiated with the same playlist URL. The generator provider provides the same master playlist, while creating new variant playlists reflecting the value of the looping parameter. In some implementations, there can be a brief interruption in playback when this occurs; in other implementations, there may be no interruption in playback.

During playback, the player user interface can send a message to the content stream generator at pre-determined intervals (e.g., once every second, and/or a similar interval), containing the player user interface's current timestamp. The video player can periodically request updated variant playlists from the stream generator via HTTP. The video player can request MPEG-2 Transport Segment (TS) files from the media repository via HTTP, corresponding to the URL provided in the #EXTINF record marker in the variant playlist. A modulo operation can be performed on player user interface controls, such that when the player's playtime exceeds the duration of the play queue, the playback controls can loop back to indicate the start of the playlist.

Dynamic HLS playlists, single play queue, single-action gestures, and looping of video content combine to improve both program assembly and viewing user experiences. The result is playback of a seamless, uninterrupted composite audiovisual program assembled by the user, with looping and adaptive bitrate delivery.

In alternate embodiments, the stream generating component 902 can be implemented as an external web service. The external web service can function independently of the primary web service, or can be integrated into the primary web service.

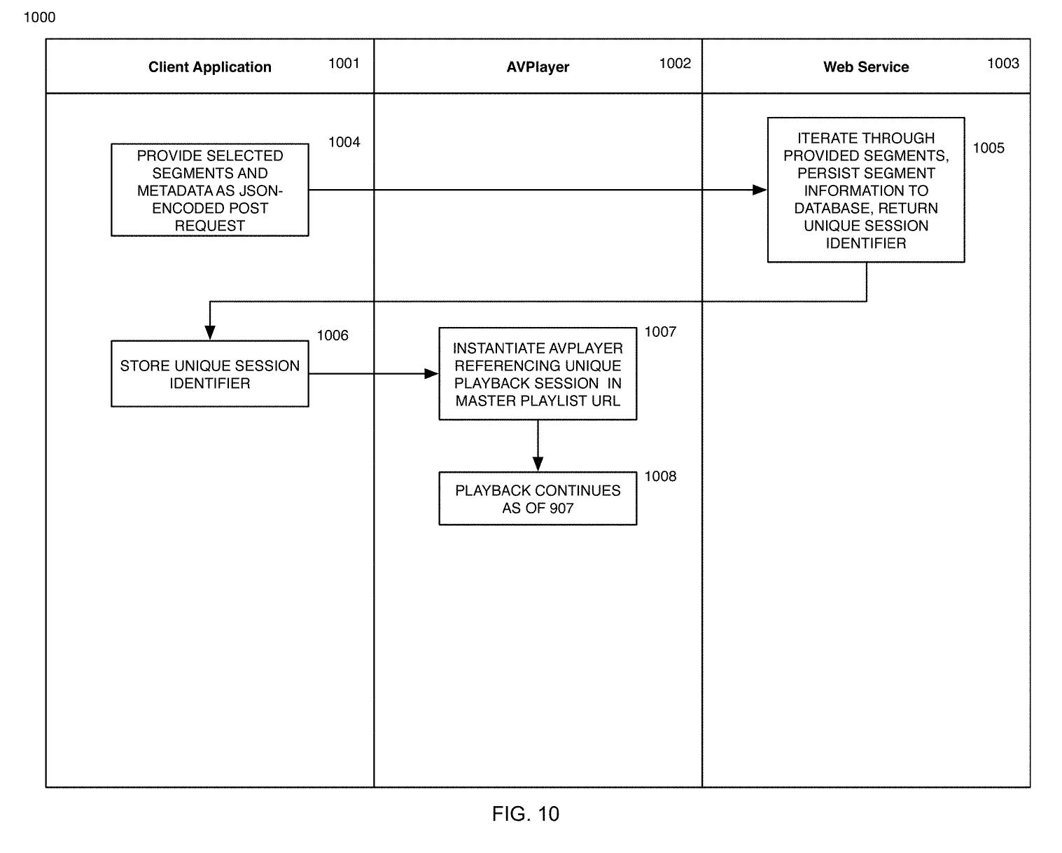

A standalone stream generating web service can host playback sessions for client applications, as illustrated in the example in FIG. 10. When the client application provides the user's play queue selections to the internal stream generator in step 905, in this embodiment, the information is instead dispatched to the web service as a JSON-encoded payload of an HTTPS POST request. When the generator receives the request, it can parse the JSON request body and perform the same preparatory steps as the internal component, shown in column 902. However, it can also create database records to persist the user's media selections and relevant meta-data between variant playlist requests. The web service can then respond with a unique playback session identifier 1005. The client application can instantiate a player user interface, with the master playlist URL directed to the external stream provider service and containing the playback session identifier. Playback can continue from block 907 in the same manner as with an internal component. As the player user interface's play time advances, requests (e.g., HTTPS PATCH requests) can be dispatched to the external stream provider with the current AVPlayer playback timestamp, which can be stored in the database. When subsequent requests arrive from the player user interface for updated variant playlists, the service can query the database to retrieve videos and current playtime, e.g., to re-construct and deliver the variant playlist, using the same approach as the internal web server.

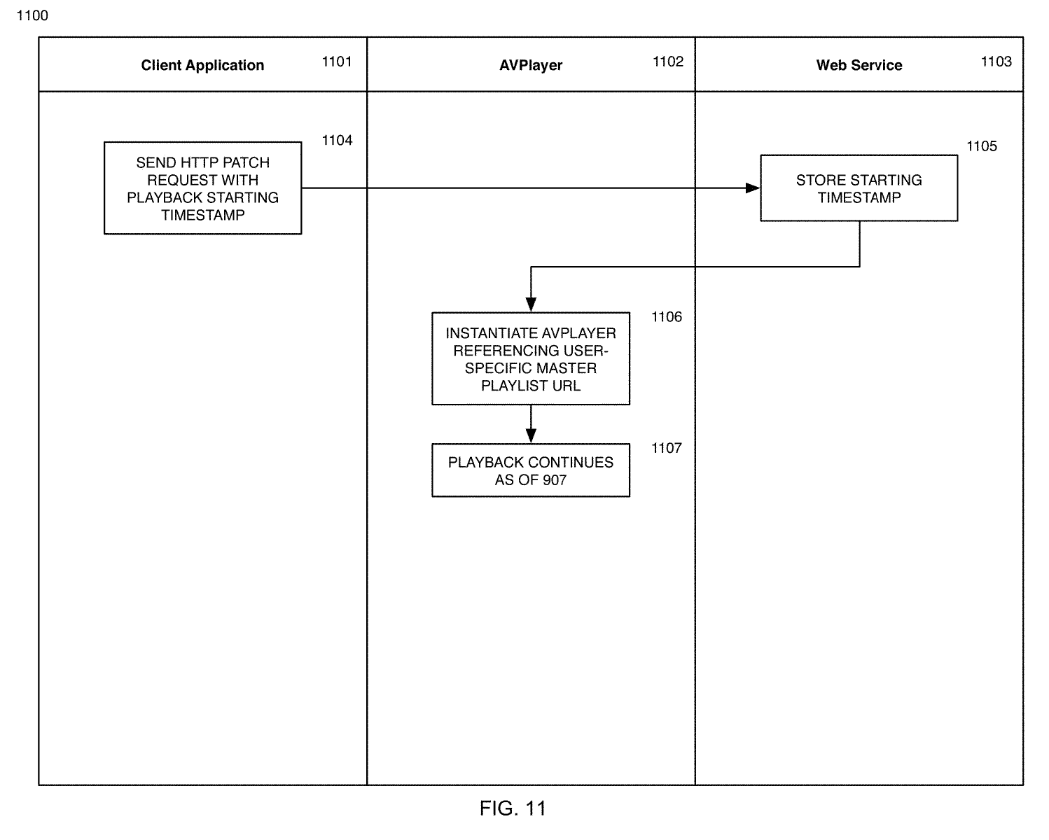

The stream generating component 902 can also be incorporated into the primary web service, as shown in the example in FIG. 11. In this embodiment, the stream generation component shares the primary web service database, and can query the user's play queue selections. The client application sends a request (e.g., an HTTPS PATCH request) to the web service indicating the timestamp from which playback should begin. The app can then instantiate a player user interface, with the master playlist URL directed to the stream generation component and containing a token to identify the user, such as the user's unique ID. The stream generation component can resolve the token to identify the user, and can query the user's play queue selections and the most recent player user interface timestamp from the database. Master and variant playlists can then be constructed in the same manner as the internal playlist generation component. Playback continues in the same manner beginning from block 907.

In some configurations, the systems and apparatus described herein include means for performing various functions as described herein. In one aspect, the aforementioned means may be a processor or processors and associated memory in which embodiments reside, and which are configured to perform the functions recited by the aforementioned means. The aforementioned means may be, for example, processor and/or memory modules or apparatus residing in modems to perform the functions described herein. In another aspect, the aforementioned means may be a module or apparatus configured to perform the functions recited by the aforementioned means, such as an application program and/or plug-in to an application program.

In one or more exemplary embodiments, the functions, methods and processes described may be implemented in hardware, software, firmware, or any combination thereof. If implemented in software, the functions may be stored on or encoded as one or more instructions or code on a computer-readable medium. The software may include an application program and/or a plug-in for use with an application program. The application program may be, for example, a mobile application.

Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above can also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The illustrated processes present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The scope of the invention is not intended to be limited to the aspects shown herein, but is to be accorded the full scope consistent with the description herein, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein.

What is claimed is:

1. A method for providing a composite audiovisual program for rendering by a video player, comprising:
receiving a request for available program segments;
sending information relating to the available program segments;
receiving selection information corresponding to selected ones of the available program segments that have been selected for inclusion in a play queue;
receiving requests for a sequence of segment files identified by variant playlist information associated with the selected ones of the available program segments wherein the variant playlist information is generated based at least in part upon resolutions of the selected ones of the available program segments; and
sending, in response to the requests, the sequence of segment files from a media repository wherein the sequence of segment files is rendered by the video player without buffering between the selected ones of the available program segments.

2. The method of claim 1 wherein the variant playlist information includes a first variant playlist and a second variant playlist;
the first variant playlist identifying a first subset of the sequence of segment files, the first subset of the sequence of segment files being selected based at least in part on a first data transfer speed between the video player and the media repository; and
the second variant playlist identifying a second subset of the plurality of segment files, the second subset of the plurality of segment files being selected based at least in part on a second data transfer speed between the video player and the media repository.

3. The method of claim 1 wherein each of the selected ones of the available program segments are selected for inclusion in the play queue in response to a single gesture provided through a user interface of an application program including the video player.

4. The method of claim 1 further including receiving, during rendering of ones of the sequence of segment files by the video player, additional selection information corresponding to additional selected ones of the available program segments that have been selected for inclusion in the play queue;
wherein the variant playlist information is dynamically altered based upon the additional selection information.

5. A method for assembling and rendering a composite audiovisual program, the method comprising:
sending a request for available program segments;
receiving information relating to the available program segments;
receiving, through a user interface of an application program including a video player, selections of ones of the available program segments for inclusion in a play queue;
generating variant playlist information identifying at least one sequence of segment files associated with the selected ones of the available program segments wherein the variant playlist information is generated based at least in part upon resolutions of the selected ones of the available program segments;
sending a request for the at least one sequence of segment files;
retrieving the at least one sequence of segment files from a media repository; and
rendering the at least one sequence of segment files without buffering between the selected ones of the available program segments.

6. The method of claim 5 wherein the generating includes iterating through each of the selections of the program segments included within the play queue to identify a highest common resolution among the selections of the program segments.

7. The method of claim 5 wherein each of the selected ones of the available program segments are selected for inclusion in the play queue in response to a single gesture provided through the user interface.

8. The method of claim 5 further including:
receiving, during rendering of ones of the sequence of segment files by the video player, additional selection information through the user interface wherein the additional selection information corresponds to additional selected ones of the available program segments that have been selected for inclusion in the play queue;
dynamically altering the variant playlist information based upon the additional selection information.

9. The method of claim 5 wherein the generating the variant playlist information includes:
generating a first variant playlist identifying a first subset of the sequence of segment files, the first subset of the sequence of segment files being selected based at least in part on a first data transfer speed between the video player and the media repository; and
generating a second variant playlist identifying a second subset of the plurality of segment files, the second subset of the plurality of segment files being selected based at least in part on a second data transfer speed between the video player and the media repository.

10. The method of claim 1 wherein the segment files are MPEG-2 Transport Segment files.

11. The method of claim 5 wherein the segment files are MPEG-2 Transport Segment files.

12. A method for providing a composite audiovisual program for rendering by a video player, comprising:
receiving a request for available program segments;
sending information relating to the available program segments;
receiving selection information corresponding to selected ones of the available program segments that have been selected for inclusion in a play queue wherein each of the selected ones of the available program segments are selected for inclusion in the play queue in response to a single gesture provided through a user interface of an application program including the video player;
receiving requests for a sequence of segment files identified by variant playlist information associated with the selected ones of the available program segments; and
sending, in response to the requests, the sequence of segment files from a media repository wherein the sequence of segment files is rendered by the video player without buffering between the selected ones of the available program segments.

13. The method of claim 12 wherein the variant playlist information is generated based at least in part upon resolutions of the selected ones of the available program segments.

14. A method for assembling and rendering a composite audiovisual program, the method comprising:
sending a request for available program segments;
receiving information relating to the available program segments;
receiving, through a user interface of an application program including a video player, selections of ones of the available program segments for inclusion in a play queue wherein each of the selections are made using a single gesture;
generating variant playlist information identifying at least one sequence of segment files associated with the selected ones of the available program segments;
sending a request for the at least one sequence of segment files;
retrieving the sequence of segment files from a media repository; and
rendering the sequence of segment files without buffering between the selected ones of the available program segments.
